(19) United States
(12) Patent Application Publication
(10) Pub. No.: US 2025/0135329 A1
(43) Pub. Date: May 1, 2025

(54) APPARATUS, SYSTEMS AND METHODS FOR CONTROLLER DEVICES

(71) Applicant: Sony Interactive Entertainment Inc., Tokyo (JP)

(72) Inventor: Lawrence Martin Green, London (GB)

(21) Appl. No.: 18/920,385

(22) Filed: Oct. 18, 2024

(30) Foreign Application Priority Data
Nov. 1, 2023 (GB) 2316741.4

(51) Int. Cl. A63F 13/22; A63F 13/79

(52) U.S. Cl. CPC A63F 13/22; A63F 13/79

(57) ABSTRACT

A data processing apparatus comprises receiving circuitry to receive controller input information indicative of one or more user inputs for a controller device comprising one or more user operable input elements, prediction circuitry to predict, for a given user operable input element of the controller device having a sensitivity setting, sensitivity update information for updating the sensitivity setting for the given user operable input element, and update circuitry to update the sensitivity setting for the given user operable input element in dependence on the sensitivity update information to obtain an updated sensitivity setting for the given user operable input element, in which the prediction circuitry is configured to predict the sensitivity update information in dependence on at least some of the controller input information associated with the given user operable input element and a prediction model which is based on previous controller input information for a plurality of users.

### CROSS-REFERENCES TO RELATED APPLICATIONS

This application claims priority to the United Kingdom (GB) Patent Application No. 2316741.4 filed Nov. 1, 2023, the contents of which are incorporated herein by reference in their entirety.

### FIELD OF THE DISCLOSURE

The present disclosure relates to controller devices. In particular, the present disclosure relates to sensitivity settings for controller devices.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior against the present disclosure.

Conventional video game controllers typically comprise user-operable input elements, such as buttons, control sticks and/or touchpads, which can be operated by a user for outputting signals to a processing device, such as a video game console, using a wired and/or wireless communication.

Some conventional video game controllers may have one or more sensitivity settings for controlling a sensitivity associated with one or more of the user-operable input elements. A sensitivity setting may be used at a device that receives controller input information from a controller for translation of the controller input information to an actual input for a program. An example of this is a sensitivity setting associated with a user-operable input element, such as a control stick, which can be varied so that a same given manipulation with respect to the user-operable input element can actually provide a different amount of actual input for a program when using different sensitivity settings. In particular, for a same given manipulation, a higher sensitivity can be used to achieve a greater amount of actual input for a program, whereas a lower sensitivity can be used to achieve a smaller amount of actual input for the program.

Typically when using a controller, a user may use a default sensitivity (e.g. a pre-programmed sensitivity) and/or a last used sensitivity which may have been set previously by another user, for example. Such a sensitivity may not be suited to the user for a number of reasons. It is in the context of the above arrangements that the present disclosure arises.

### BRIEF SUMMARY

Various aspects and features of the present disclosure are defined in the appended claims and within the text of the accompanying description. Example embodiments include at least a data processing apparatus, a system, a method, a computer program and a machine-readable non-transitory storage medium which stores such a computer program.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating an example of an entertainment device;

FIG. 2 is a schematic diagram illustrating an example of a video game controller;

FIG. 3 is a schematic diagram illustrating a data processing apparatus in accordance with embodiments of the disclosure;

FIG. 4 is a schematic diagram illustrating a system in accordance with embodiments of the disclosure;

FIGS. 5A, 5B, and 5C are schematic diagrams illustrating a movement of a control stick and a corresponding registered input for a software program; and

FIG. 6 is a schematic flowchart of a method in accordance with embodiments of the disclosure.

### DETAILED DESCRIPTION OF THE EMBODIMENTS

In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

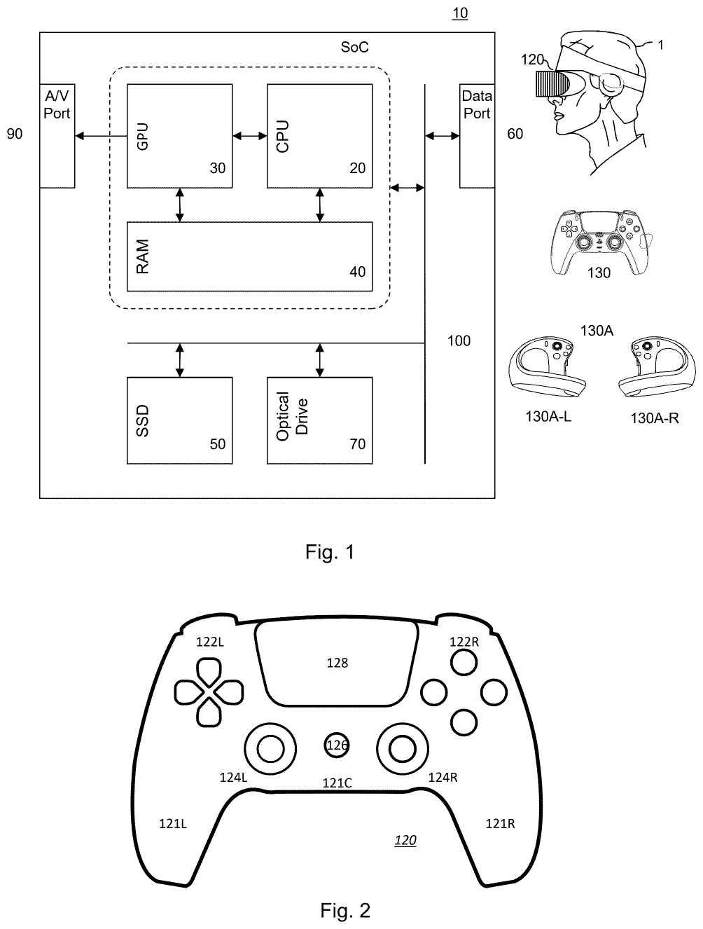

Referring now to the drawings, wherein like reference numerals designate identical or corresponding parts, FIG. 1 shows an example of an entertainment device 10 which may be a computer or video game console, for example.

The entertainment device 10 comprises a central processor or CPU 20. This may be a single or multi core processor. The entertainment device may also comprise a graphical processing unit or GPU 30 and RAM 40. The GPU can be physically separate to the CPU, or integrated with the CPU as a system on a chip (SoC). More generally, two or more of the CPU, GPU and RAM may be integrated as a SoC.

Further storage may be provided by a disk 50, either as an external or internal hard drive, or as an external solid state drive, or an internal solid state drive.

The GPU, optionally in conjunction with the CPU, may process data and generate video images (image data) and optionally audio for output via an AV output. Optionally, the audio may be generated in conjunction with or instead by an audio processor (not shown).

The video and optionally the audio may be presented to a television or other similar device. Where supported by the television, the video may be stereoscopic. The audio may be presented to a home cinema system in one of a number of formats such as stereo, 5.1 surround sound or 7.1 surround sound. Video and audio may likewise be presented to a head mounted display unit worn by a user.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90, or one or more of the data ports 60.

Where components are not integrated, they may be connected as appropriate either by a dedicated data link or via a bus 100.

An example of a device for displaying images output by the entertainment device is a head mounted display ‘HMD’ 120 worn by a user 1. The images output by the entertainment device may be displayed using various other devices—e.g. using a conventional television display connected to A/V ports 90.

Interaction with the device is typically provided using one or more handheld controllers, examples of which may include controller 130 and/or one or more VR controllers 130A-L, 130A-R. The user typically interacts with the system by providing inputs via the handheld controllers 130, 130A. For example, when playing a game, the user may navigate around a game environment by providing inputs using the handheld controllers 130 and/or 130A.

FIG. 1 therefore provides an example of a data processing apparatus suitable for processing one or more programs, such as a video game, in accordance with user inputs.

In FIG. 2, an example controller device 120 is illustrated. Whilst FIG. 2 illustrates an example of a suitable video game controller, the techniques of the present disclosure are not limited to video game controllers and may be applicable to controller devices more generally such as television controllers as well as other similar remote controllers and the like.

FIG. 2 illustrates an example of a handheld video game controller 120 suitable for use in the techniques of the present disclosure. Other controller devices (such as VR controllers 130A-L, 130A-R) are also considered. For example, the techniques of the present disclosure may be implemented using a one-handed and/or two handed controller device and the properties of the controller device are not particularly limited. In the techniques of the present disclosure, the controller device may take any suitable form.

The example controller 120 has two handle sections 121L, 121R and a central body 121C. Various input elements may be distributed over the controller, in some cases in local groups. Examples include a left button group 122L, which may comprise directional controls and/or one or more shoulder buttons (optionally comprising one or more adaptive trigger buttons), and similarly a right button group 122R, which may comprise function controls and/or one or more shoulder buttons (optionally comprising one or more adaptive trigger buttons). In the example of FIG. 2, the controller also includes left and/or right control sticks 124L, 124R, which may optionally also be operable as buttons by pressing down on them.

The control sticks 124L, 124R generally include a stem portion that protrudes from the housing of the controller 120 and an upper portion upon which a user is able to position their digit (e.g. thumb). Such control sticks may provide a two-dimensional input (X,Y) which may be used as an input to a program such as a video game or other interactive application. During use, a user's thumb (or other digit) may typically rest on a top surface of a control stick and pressure applied may manoeuvre the control stick.

The control stick may have a neutral position (which is a default position adopted by the control stick when no force is applied thereto) and operations by a user with respect to the control stick are performed to move and thus displace the control stick from the neutral position (e.g. a central position with respect to range of movement in an X direction and a Y direction) to thereby provide inputs. The neutral position may correspond to a position that is central with respect to a range of movement of the control stick. Hence in the case of a control stick capable of being moved to provide input with respect to two positional axes (e.g. a Y axis and an X axis, with an optional Z axis for cases in which depressing of the control stick inward towards a housing of the controller device is also provided), the neutral position may correspond to a central point (or portion) of the movement range with respect to the Y axis and the X axis.

A base of the control stick may be coupled to suitable circuitry for providing signals that are dependent on the displacement of the control stick relative to the neutral position (and/or another reference position). An example of suitable circuitry may be one or more potentiometers housed within the controller body to provide an electrical output. Such circuitry is known and is thus not discussed in detail. Generally, an analog control stick may have two associated potentiometers to provide a continuous electrical output proportional to a displacement relative to a neutral position. Such outputs may be digitised using one or more ADCs of the controller device.

The controller (typically in the central portion of the device) may also comprise one or more system buttons 126, which typically cause interaction with an operating system of an entertainment device rather than with a game program currently running on it; such buttons may summon a system menu, or allow for recording or sharing of displayed content. Furthermore, the controller may comprise one or more other elements such as a touchpad 128 for sensing touch inputs by a user, a light for optical tracking (not shown), a screen (not shown), haptic feedback elements (not shown), and the like.

The operations to be discussed below relate to techniques for improving usability of controller devices. The inventors have identified that there is a need to improve usability of controller devices having one or more adjustable sensitivity settings.

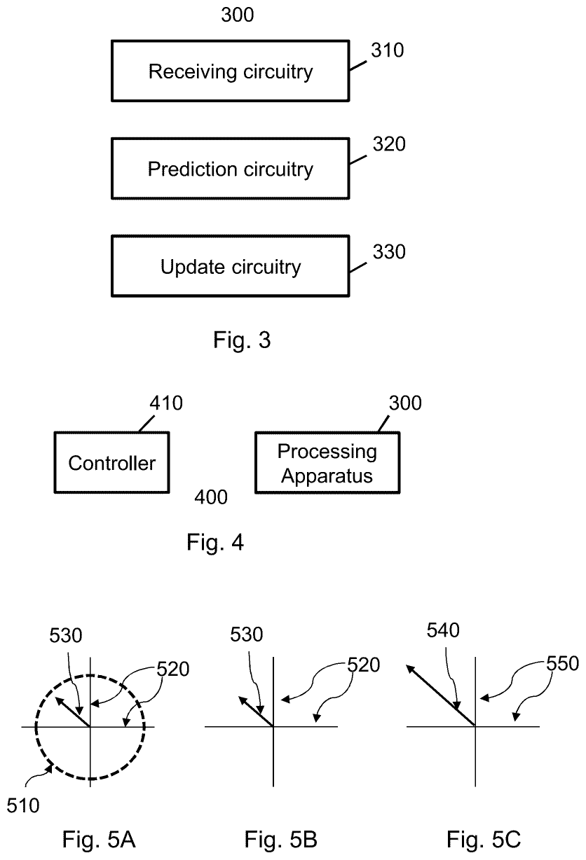

FIG. 3 schematically illustrates a data processing apparatus 300 in accordance with embodiments of the disclosure. The data processing apparatus 300 comprises receiving circuitry 310, prediction circuitry 320 and update circuitry 330.

The receiving circuitry 310 is configured to receive controller input information indicative of one or more user inputs for a controller device comprising one or more user operable input elements. The controller device may for example be a video game controller device such as the example controller device 120 discussed with respect to FIG. 2. Other possibilities include a mouse input device, steering wheel input device, joystick input device, or other similar input devices. For example, a steering wheel device may comprise a rotatable steering wheel portion, one or more buttons and potentially one or more trigger buttons positioned to a rear of the 10 rotatable steering wheel portion for providing functions such as gear changing. The controller device may take any suitable form.

The receiving circuitry 310 may receive the controller input information via one or more of a wired and/or wireless communication and may receive the controller input information directly from the controller device or via one or more other devices. In some examples, the data processing apparatus 300 may be connected to the controller device via a wired (e.g. USB) and/or wireless connection (e.g. Bluetooth® and/or Wi-Fi®) with the controller device. The controller may be operable to transmit the controller input information (e.g. as packets such as Bluetooth® packets or packets for a suitable wired connection) for reception by the data processing apparatus 300.

The receiving circuitry 310 may receive streamed controller input information during execution of a session for a program (e.g. video game). In such cases, the techniques to be discussed below may update a sensitivity setting during a session for a video game. For example, controller inputs during a given time window during a session may be evaluated according to the techniques below and an update to a sensitivity setting may be performed so that an update sensitivity setting is subsequently used during the session. Alternatively, the receiving circuitry 310 may receive recorded controller input information for a previous session for a video game. The recorded controller input information may be received after a previous session has ended so as to analyse the recorded controller input information and update a sensitivity setting so that at a later time a next session can be processed using the updated sensitivity setting. Hence, in some cases the receiving circuitry 310 may receive recorded controller input information corresponding to an entirety (or a portion) of a previous session to allow an evaluation thereof for potentially updating a sensitivity setting. In some examples, in response to a request from a user to start a session for a video game, a recording of controller input information for that user from a previous session may be received by the receiving circuitry and evaluated according to the techniques below so as to update one or more default sensitivity settings based on the recording to obtain one or more updated sensitivity settings for the user.

The controller device comprises one or more user-operable input elements which may for example comprise any of the user-operable input elements discussed previously with respect to FIG. 2. In some embodiments of the disclosure, the one or more user-operable input elements comprise one or more from the list consisting of: one or more buttons; one or more control sticks; one or more touchpads; and one or more trigger buttons (e.g. adaptive trigger buttons). For example, a control stick may be moved a small amount or a relatively large amount to provide different amounts of input. Similarly, a trigger button may be moved a small amount (e.g. only slightly depressed and/or rotated) or a relatively large amount, and drag inputs (or swipe input) with respect to a surface of a touchpad may have different sizes. More generally, the techniques of the present disclosure can allow for updating of a sensitivity setting associated with a respective user operable input element that is capable of being used by a user to provide a varying degree of input.

A user may thus operate one or more user-operable input elements (e.g. buttons, touchpads, control sticks), and the controller device is operable to generate and output controller input information indicative of one or more user inputs with respect to one or more of the user-operable input elements. The controller input information can be communicated to the data processing apparatus 300, either directly or indirectly.

In some embodiments of the disclosure, the data processing apparatus 300 may be provided as part of a server. The receiving circuitry 310 may thus receive the controller input information via one or more wireless communications networks (e.g. one or more local area networks and/or one or more wide area networks, such as the Internet). In some embodiments of the disclosure, data processing apparatus 300 may be provided as part of a server associated with a cloud gaming service.

In other embodiments of the disclosure, the data processing apparatus 300 may be provided as part of a user device. For example, the data processing apparatus 300 may be a personal computing device such as a laptop device, tablet device, smartphone device, game console device or other similar device. In some embodiments of the disclosure, the data processing apparatus 300 may be provided as part of an entertainment device such as the example entertainment device discussed with respect to FIG. 1.

In some embodiments of the disclosure, the data processing apparatus 300 may comprise processing circuitry to process one or more programs in dependence on the controller input information received by the receiving circuitry 310. For example, the data processing apparatus 300 may be a video game processing device (e.g. a gaming server or a video game console) comprising processing circuitry to process a video game played by the user using the controller device. Alternatively, in some embodiments of the disclosure the data processing apparatus 300 may receive the controller input information solely for the purposes of the techniques to be discussed below (namely, predicting sensitivity update information) and another device may be responsible for processing one or more programs. Hence, in some cases the data processing apparatus 300 may be a dedicated device for updating one or more sensitivity settings. The data processing apparatus 300 may for example be a server that receives controller input information from a potentially large number of users and which evaluates received requests and provides updated sensitivity settings which when used can improve usability of controller devices by those users.

In some embodiments of the disclosure, a system may comprise the data processing apparatus 300, a controller device (e.g. example controller device 120) and a further device (e.g. a game console) for processing one or more software programs in dependence on controller input information. Hence, the controller device may be operable to output the controller input information to each of the data processing apparatus 300 and the further device (or the apparatus 300 may receive the controller input information via the further device). In this case, the controller input information can be used by the data processing apparatus 300 for predicting sensitivity update information and also used by the further device for concurrently processing a software program (e.g. a video game program). For example, the further processing device may be a video game console and the data processing apparatus 300 may be provided as part of a server device.

Referring now to FIG. 4, in some embodiments of the disclosure, a system 400 comprises the data processing apparatus 300 and a controller device 410. The controller device 410 may take any suitable form. In some examples, the controller device 410 may be a two-handed video game controller such as the example controller 120. As explained above, the data processing apparatus 300 may comprise processing circuitry (e.g. video game processing circuitry) operable to execute a program (e.g. video game program) in dependence on the controller input information. FIG. 4 represents an example in which the data processing apparatus 300 is operable to receive controller input information from the controller 410 via one or more of a wired and/or wireless communication. The data processing apparatus 300 can process a computer program (e.g. video game program) in dependence on the received controller input information, and the received controller input information can additionally be used by the prediction circuitry 320 according to the techniques to be discussed below for prediction of sensitivity update information to update a sensitivity setting used by the data processing apparatus 300 for the controller device 410.

Hence, in some cases the data processing apparatus 300 may use the received controller input information to execute one or more programs whilst also using at least some of the received controller input information for predicting sensitivity update information.

For example, during playing of a video game using the controller device 410, the controller input information may be used to progress the video game and at least some of the controller input information may be used by the prediction circuitry 320 for predicting sensitivity update information for allowing an update to a current sensitivity setting associated with the controller device during and/or after the session for the video game.

Controller devices having one or more adjustable sensitivity settings may use an initial sensitivity (e.g. a default sensitivity or a last used sensitivity set when the controller device was last used) for one or more user-operable input elements. Alternatively, a user may initially choose an initial sensitivity for one or more user-operable input elements (e.g. using one or more menu screens) and proceed to use the controller device using the initial sensitivity even though, potentially unbeknown to the user, a different sensitivity may be better suited for the user. Hence more generally, it is desirable to allow adjustment of a sensitivity setting to improve usability of a controller device for a user. For example, such adjustment may improve usability by potentially reducing user fatigue, improving performance (e.g. gameplay performance) and/or addressing potential mobility issues.

Referring again to FIG. 3, the prediction circuitry 320 is configured to predict, for a given user operable input element of a controller device having a sensitivity setting, sensitivity update information for updating the sensitivity setting for the given user operable input element. Referring to the example controller 120, an adjustable sensitivity setting may be associated with one of a control stick (e.g. control stick 124L, 124R), trigger button (e.g. an adaptive trigger button positioned on or near a should portion) and touchpad (e.g. touch pad 128). The prediction circuitry 320 is operable to predict sensitivity update information for updating such a sensitivity setting. In particular, the prediction circuitry 320 is configured to predict sensitivity update information for updating at least one sensitivity setting for a given user operable input element of a controller device in dependence on at least some of the received controller input information associated with the given user operable input element and a prediction model. The prediction model is based on previous controller input information for a plurality of users (e.g. historical controller input information) and may take a number of different forms. The prediction model is discussed in more detail later.

The prediction circuitry 320 is thus configured to predict sensitivity update information for updating a sensitivity setting for a respective user operable input element in dependence on at least some of the received controller input information and the prediction model, and the update circuitry 330 is configured to update the sensitivity setting for the respective user operable input element in dependence on the sensitivity update information to thereby obtain an updated sensitivity setting for the respective user operable input element.

In some embodiments of the disclosure, the data processing apparatus 300 may comprise storage circuitry to store sensitivity information for the controller device for specifying one or more sensitivity settings for one or more user operable input elements of the controller device. For example, the data processing apparatus 300 may be a video game apparatus for executing a session of a video game program (e.g. a game console or a server), and may comprise storage circuitry to store sensitivity information for specifying one or more sensitivity settings for the controller device and which are to be used by the apparatus 300 for execution of a program (e.g. video game). Hence, the update circuitry 330 may be configured to update a stored sensitivity setting for a respective user operable input element in dependence on the sensitivity update information. Hence more generally, in some embodiments of the disclosure the data processing apparatus 300 may comprise processing circuitry (not shown in FIG. 3) to process a video game in dependence on the controller input data and setting information stored by the data processing apparatus 300.

In other embodiments of the disclosure, the data processing apparatus 300 may be provided as a device that is separate to an entertainment device or video game apparatus, and the update circuitry 320 may provide updates for updating a sensitivity setting to be used (or being used) by the entertainment device or video game apparatus. For example, the data processing apparatus 300 may be a server apparatus (or smartphone device) that outputs one or more updates in dependence on the sensitivity update information for updating a sensitivity setting at a video game processing device (e.g. a gaming server or a user's entertainment device).

More generally, the data processing apparatus 300 is operable to update a sensitivity setting associated with at least one user operable input element of a controller device so as to obtain an updated sensitivity setting which either corresponds to a greater sensitivity or a reduced sensitivity relative to the sensitivity setting prior to being updated. For example, the initial sensitivity setting may be adjusted to increase sensitivity so that for a same movement of a control stick or a trigger button, a larger in-program movement (e.g. movement of a cursor or an in-game movement, or movement of a player character in a video game) is achieved. Conversely, the initial sensitivity setting may be adjusted to decrease sensitivity so that for a same movement of a control stick or a trigger button, a smaller in-program movement is achieved. Similarly, the initial sensitivity setting may be adjusted to increase or decrease sensitivity so that for a same touch input movement by a user's digit with respect to a touch pad (e.g. a drag input), a larger or smaller in-program movement is achieved. The terms in-program movement, actual input for a program and registered input are used interchangeably.

In some examples, a sensitivity setting associated with a control stick may comprise a parameter for controlling sensitivity with respect to movement for the control stick. A respective parameter may control sensitivity for two axes of movement for the control stick so that a same sensitivity is used for the two axes, or two respective parameters may be used so that different sensitivities can be used for the two axes. In the case of a control stick, a displacement of the control stick relative to the neutral position can be used to achieve in-program movement (e.g. movement of a cursor or movement in a video game, such as movement of an in-game character). For example, movement of the control stick may be used to cause an in-game character to move from one position to another position in a game world. Alternatively, movement of the control stick may be used to cause the in-game character to rotate about a point so as to rotate a viewpoint. More generally, a first control stick may have an assigned function for controlling a first type of in-game movement for an in-game character (e.g. changing position) and a second control stick may have an assigned function for controlling a second type of in-game movement (e.g. changing an orientation of an in-game character). Hence, a user may simultaneously operate the two control sticks to control an in-game character to move within and explore a game world. Other possible functions associated with movement of a character may be similarly assigned.

In some embodiments of the disclosure, the controller device may comprise one or more control sticks, and the update circuitry 330 may be operable to update a sensitivity setting for a control stick by updating a parameter that controls sensitivity associated with movement for the control stick to obtain an updated sensitivity setting for the control stick. Hence, for a same given displacement of a control stick from its neutral position, a different amount of in-program movement can be achieved by varying the value of the parameter. For example, the value of the parameter may be used to apply a scaling factor to the displacement of the control stick to thereby obtain an in-program movement. More generally, a relationship between an amount of movement of the control stick and a corresponding in-program movement can be controlled based on the value of the parameter, and the value of the parameter can be updated based on the predicted sensitivity information.

FIGS. 5A-C schematically illustrate an example of a movement of a control stick (e.g. 124L or 124R) from a neutral position and a corresponding in-program movement (also referred to as a registered input for a program). In this example, the control stick has a circular displacement limit (range of motion) as shown by the dashed line 510. Such a circular displacement limit may be due to a housing of the controller contacting a portion of a stem of the control stick and/or due to the arrangement used for coupling the control stick to the controller. In other examples, the displacement limit may have a different shape such as a square, rectangular, hexagonal, octagonal shape or other polygonal shape.

In FIG. 5A, movement of the control stick is defined with respect to two axis 520 of a real-world space, with the neutral position corresponding to the centre of the movable range for the control stick. In some examples, a so-called dead zone (dead spot) may optionally be defined to surround the neutral position such that displacements (movements) of the control stick within the dead zone do not result in in-program movement. Such a dead zone may be specified by a sensitivity setting which may be updated by the update circuitry 330. Hence, whilst a controller device may output controller input data indicative of small movement(s) of a control stick away from the neutral position, a sensitivity setting used by a processing device may specify a size for a dead-zone region resulting in such small movements having no contribution to in-program movement. The example of FIG. 5A shows a case in which either no such dead zone is present or the movement being discussed (represented by arrow 530) results in displacement of the control stick outside the dead zone.

In FIG. 5A, the movement of the control stick relative to the neutral position is schematically illustrated by the arrow 530. Such a movement of the control stick may be achieved by a user's digit (e.g. thumb) pushing (or pulling) the control stick in the direction of the arrow 530 to thereby displace the control stick from the neutral position.

FIG. 5B schematically illustrates the movement of the control stick relative to the neutral position with respect to the two axis 520 of the real-world space (in FIG. 5B the dashed line 510 has been removed for clarity of explanation when comparing FIGS. 5B and 5C). FIG. 5C schematically illustrates a corresponding in-program movement 540 obtained by applying a sensitivity setting for the controller input information associated with the movement 530 for the control stick. It will be appreciated that FIG. 5B illustrates the control stick movement 530 with respect to the two axis 520 in real-world space, and FIG. 5C illustrates a corresponding in-program movement with respect to two axis 550 associated with a coordinate system for a program (e.g. a virtual coordinate system associated with a game world for a video game). For example, the two axes 550 may correspond to screen space coordinates such that the movement 540 represents a movement of a cursor within a screen space. In other examples, the two axes 550 may correspond to two positional axes of a game world (e.g. a virtual reality world) such that the movement 540 represents movement from one position to another position in the game world. Similarly, the two axes 550 may correspond to two axes of rotation (e.g. pitch, yaw), such that the movement 540 represents rotation in the game world. The magnitude of the movement 540 is obtained in dependence on the magnitude of the movement 530 and a current value of a parameter for the sensitivity setting for the control stick. It will be appreciated that by varying the parameter, the magnitude of the movement 540 can be varied to achieve a smaller or larger movement for a same given input using the control stick.

In the techniques of the present disclosure, the data processing apparatus 300 can be operable to receive controller input information indicative of user inputs with respect to a control stick, predict sensitivity update information for updating a sensitivity setting associated with the control stick in dependence on at least some of the controller input information, and update the sensitivity setting based on the sensitivity update information so as to obtain an updated sensitivity setting so that an increased or decreased sensitivity can subsequently be used for the control stick.

The above discussion refers to an example of a sensitivity setting with respect to a control stick. The same techniques may similarly be applied with respect to another type of user operable input element such as a trigger button and/or a touchpad.

For example, a trigger button (e.g. adaptive trigger button) may be arranged on a portion of a controller and have a default position to which the trigger button may be biased by a biasing means (e.g. a spring or other suitable element). The trigger button may be arranged such that a user's digit can contact a surface of the trigger button to move the trigger button from the default position towards another position, with the trigger button capable of having a range of configurations between the default position and a closed position for the trigger button. For example, the trigger button may be capable of being pressed to follow a fixed path (e.g. a straight or curved path) from the default position to the closed position and capable of being held by the user at a point along the fixed path. Hence, more generally the trigger button is capable of being displaced different amounts from the default position for providing a varying degree of input. A parameter associated with sensitivity for the trigger button can be updated in a manner similar to that discussed above in relation to FIGS. 5A-5C so as to vary the amount of in-program movement achieved for a given amount of movement of the trigger button.

Similarly, a touchpad may be provided which can be contacted by a user's digit(s) to provide positional inputs with respect to the touchpad. For example, a dragging operation in which a digit (e.g. thumb) is dragged across a surface of the touchpad and/or a pinch operation using two or more digits may be performed. A parameter associated with sensitivity for the touchpad can be updated in a manner similar to that discussed above so as vary an amount of in-program movement for a given amount of movement with respect to the to the touch pad.

Hence more generally, in some embodiments of the disclosure the receiving circuitry 310 can be operable to receive controller input information indicative of one or more user inputs for a controller device comprising one or more user operable input elements, in which the controller input information is indicative of one or more from the list consisting of: positional displacements for a control stick device; positional displacements for a trigger device; and positions of touch inputs with respect to a touch pad device.

The prediction circuitry 320 can predict sensitivity update information for updating a sensitivity setting associated with a control stick in dependence on at least some of the received controller input information indicative of positional displacements for the control stick device and the prediction model. Alternatively or in addition, the prediction circuitry 320 can predict sensitivity update information for updating a sensitivity setting associated with a trigger button in dependence on at least some of the received controller input information indicative of positional displacements for the trigger button and the prediction model. Alternatively or in addition, the prediction circuitry 320 can predict sensitivity update information for updating a sensitivity setting associated with a touchpad in dependence on at least some of the received controller input information indicative of positions of touch inputs with respect to the touchpad.

Hence the prediction circuitry 320 may be configured to predict sensitivity update information for updating a sensitivity setting for a given user operable input element. The sensitivity update information may comprise one or more from the list consisting of: control stick sensitivity update information, trigger button sensitivity update information, and touchpad sensitivity information.

For example, received controller input information indicative of positional displacements for a control stick device (or similarly a trigger button or touch pad) during a given period of time (e.g. a time period in the range 30 seconds to 300 seconds) may be evaluated using the prediction model to thereby predict sensitivity update information. For example, the controller input information indicative of the positional displacements for the given user operable input element during a period of time may be processed to obtain one or more properties such as one or more from the list consisting of: a total positional change for the user operable input element during the period of time (e.g. total distance travelled by the control stick obtained by summing the displacements during the period); a number of times a displacement limit for the user operable input element is attained by the user operable input element during the period of time; an average (e.g. mean) displacement for the user operable input element during the period of time. Other similar properties may be used and one or more such properties may be evaluated using the prediction model.

As explained previously, such controller input information may relate to a recording of inputs from a previous session for a video game. In this case, the entirety (or a selected portion) of the controller input information may be analysed for obtaining a prediction of the sensitivity update information. For example, a temporal portion having a duration in the range 60 to 300 seconds may be selected for analysis. In other examples, the controller input information may be streamed to the apparatus 300 and used for analysis by analysing the controller input information received within a given time window (e.g. a window having a duration in the range to 300 seconds).

Hence, more generally, in some embodiments of the disclosure, the prediction circuitry 320 may be configured to predict the sensitivity update information for updating a sensitivity setting associated with a given user operable input element in dependence on at least some of the received controller input information indicative of positional displacements for the given user operable input element during a period of time and the prediction model.

The prediction model is based on previous controller input information for a plurality of users. The evaluation using the prediction model can be used to characterise the received controller input information for the user relative to previous controller input information for other users. For example, using the prediction model, the received controller input information for the control stick can be evaluated as being indicative of one of a relatively high amount of control stick movement, a relatively low amount of control stick movement, and a relatively normal amount of control stick movement (with respect to the previous controller input information for the plurality of users). Generally speaking, a relatively high amount of movement may be associated with an increased likelihood of fatigue and/or may be associated with slower in-game movements (due to the potentially increased time associated with performing a larger physical movement). A relatively low amount of movement may potentially be associated with a number of factors. For example, an overly sensitive setting being used which may place a greater burden on the user and/or may be associated with overly jump in-game movements.

In some examples, controller input information indicative of positional displacements for a respective control stick during a given time interval (e.g. X minutes, where X is a value in the range 1 to 10) may be analysed to calculate a total distance travelled by the control stick. In addition, the prediction model may group the historical controller input information for the plurality of users according to a property of total distance travelled by a control stick during a given time interval. For example, a decile analysis or other similar data categorisation technique may be used. A threshold distance travelled by the control stick during the given time interval can thus be identified using the prediction model and used as a condition such that in response to the controller input information being indicative of motion exceeding the threshold, sensitivity update information can be predicted for increasing a sensitivity. This can potentially mitigate the relatively high amount of physical movements by the user. This represents an example of using distance travelled by a control stick as a proxy for inferring an amount of physical movement performed by a user. It will be appreciated that other similar properties associated with movement of an input element (e.g. control stick, trigger button and/or touchpad) may similarly be identified and evaluated with respect to a suitable threshold identified based on the historical controller input information.

Hence more generally, at least some of the received controller input information indicative of positional displacements for a given user operable input element during a period of time can be evaluated using the prediction model. In response to a characterisation of a relatively high amount of motion for the given user operable input element (which may be associated with an increase likelihood of fatigue), sensitivity update information can be predicted for increasing a sensitivity associated with the given user operable input element.

In particular, using the prediction model, a threshold amount of motion can be specified and, conditional on the received controller input information exceeding the threshold, the sensitivity update information can be predicted for increasing sensitivity. In this way, for a user exhibiting a relatively high amount of motion for one or more user operable input elements, which may be associated with an increased likelihood of fatigue (and/or relatively slow timings for movements in a program which may for example be detrimental to gameplay performance), sensitivity update information for increasing sensitivity can be provided to potentially alleviate such issues. The threshold amount of motion may be identified based on a distribution of the previous controller input information. For example, the previous controller input information for the plurality of users (or population of users) may be divided into deciles (or other similar divisions) and the threshold may be set according to an amount of movement associated with one of the deciles (e.g. any one of a sixth to ninth decile may be suitable for this purpose) so that in response to the received controller input information corresponding to a decile above a certain threshold, the sensitivity update information can be predicted for increasing sensitivity. Of course, whilst the above example refers to division using deciles, a more granular division may be used in some samples and the threshold can be freely set by a developer.

Hence, the prediction circuitry 320 may be configured to predict the sensitivity update information for increasing sensitivity associated with the given user operable input element in dependence on whether the at least some of the received controller input information is indicative of an amount of motion exceeding a threshold amount of motion associated with the prediction model. Optionally, a second threshold amount of motion lower than the above mentioned threshold amount of motion may also be identified based on the prediction model, such that the in response to at least some of the received controller input information being indicative of an amount of motion that is less than the second threshold amount of motion, sensitivity update information for decreasing sensitivity can be provided. For example, such a situation may arise due to use of an overly high sensitivity being used initially. For example, the second threshold amount of motion may be set according to an amount of movement associated with one of the deciles (e.g. any one of a first to fourth decile).

Therefore, controller input information indicative of physical motion with respect to a given user-operable input element (e.g. control stick, touch pad and/or trigger button) can be evaluated using the prediction model and sensitivity update information can potentially be predicted for updating the sensitivity setting for the given user operable input element in a way that may subsequently result in the user compensating for the updated sensitivity setting by performing a smaller amount of movement or a greater amount of movement that is considered more normal relative to the historical data for the plurality of users.

The above discussion refers to predicting the sensitivity update information in dependence on at least some of the controller input information and the prediction model. The techniques above can potentially be performed without considering a current sensitivity setting for a user operable input element.

In some embodiments of the disclosure, the data processing apparatus 300 can be operable to process the received controller input information using a current sensitivity setting associated with the received controller input information.

In some embodiments of the disclosure the prediction circuitry 320 is configured to use the prediction model to evaluate motion of the given user operable input element during a period of time and the sensitivity setting for the given user operable input element relative to the previous controller input information, and predict the sensitivity update information in dependence on the evaluation relative to the previous controller input information. Hence, in some cases both the motion (positional displacements) of the given user operable input element and the sensitivity setting being used for the given user operable input element during a period of time can be used. In particular, the motion (positional displacements) of the given user operable input element and the sensitivity setting can be used to obtain an amount of in-program movement which can be evaluated using the prediction model.

As explained previously, using motion of a given user operable input element and a sensitivity setting, an in-program movement (registered input) for a software program can be calculated. For example, the controller input data may be input to an input translator function for translating a movement associated with an input element to an in-program movement, in which the input translator function uses one or more sensitivity settings. Generally, techniques for converting controller input information from a controller device to a registered input for a program are known and are not discussed in detail.

Using the prediction model, the received controller input information for a given user operable input element can be evaluated as being indicative of one of a relatively high amount of in-program movement, a relatively low amount of in-program movement, and a relatively normal amount of in-program movement (with respect to the previous controller input information for the plurality of users). Generally speaking, a relatively high amount of in-program movement may be associated with a current sensitivity setting being too sensitive. For example, in the case of overly high sensitivity, a user may perform an initial movement with poor accuracy and subsequently require a number of sharp corrective movements resulting in a relatively high amount of movement. For such cases, prediction of sensitivity update information to reduce sensitivity can potentially mitigate the relatively high amount of in-program movements.

In some embodiments of the disclosure, the prediction circuitry 320 may be configured to calculate an amount of in-game motion in dependence on the motion for the given user operable input element during the given period of time and the sensitivity setting for the given user operable input element, and the prediction circuitry 320 may be configured to use the prediction model to classify the received controller input information according to a classification from a plurality of candidate classifications corresponding to different levels of in-game motion.

For example, using the controller input information and the sensitivity setting, a total distance travelled by a character or vehicle in a video game for a period of time may be calculated. Alternatively or in addition, a total distance travelled by a virtual camera that is being controlled using a user operable input element may be calculated for a period of time. Alternatively or in addition, a total change in rotation (e.g. pitch and/or yaw and/or roll) of a virtual camera that is being controlled using a user operable input element may be calculated for a period of time.

Similarly to that discussed previously with respect to positional displacements for a respective control stick during a given time interval, the prediction model may group the historical controller input information for the plurality of users according to a property of total in-game movement during a period of time. For example, the prediction model may group the historical controller input information for the plurality of users according to a property of total distance travelled by an in-game character (or virtual camera) during a period of time. Alternatively or in addition, the prediction model may group the historical controller input information according to a property of total rotational changes (e.g. a total number of respective rotational changes or a sum of each change in rotation) by an in-game character. For example, a decile analysis or other similar data categorisation technique may be used. More generally, a threshold in-game movement (e.g. distance travelled) during the period of time can thus be identified using the prediction model and used as a condition such that in response to the controller input information being indicative of in-game movement (e.g. distance travelled) exceeding the threshold, sensitivity update information can be predicted for decreasing a sensitivity.

In particular, in some examples the controller input information may be used for playing a racing game in which a user navigates a racing track or other similar course using a vehicle. The prediction model may be based on historical user input data for other users for a same racing game. Evaluation of the user relative to the other users can indicate properties such as the user having a relatively higher amount of motion for certain portions of a racing track potentially being indicative of oversteer by the user and which may potentially be at least partially alleviated by a reduction in sensitivity associated with a user operable input element (e.g. control stick) being used by the user. Conversely, such evaluation may indicate properties such as the user having a relatively lower amount of motion for certain portions of a racing track potentially being indicative of understeer and which may potentially be at least partially alleviated by an increase in sensitivity associated with a user operable input element so that for a same magnitude of physical input by the user a greater amount of in-game motion is achieved. Of course, such techniques are not limited to racing games and may be applicable for other types of video game such as role playing games and shooter video games (e.g., first person shooters).

Hence, the prediction circuitry 320 may be configured to use the prediction model to classify the received controller input information according to a classification from a plurality of candidate classifications corresponding to different levels of in-game motion. For example, the plurality of candidate classifications may correspond to respective deciles with respect to the historical controller input information or other similar divisions.

In response to a classification corresponding to a level of in-game motion greater than a first threshold level of in-game motion, the prediction circuitry 320 may be configured to predict the sensitivity update information for decreasing the sensitivity setting for the given user operable input element. The first threshold level of in-game motion can be identified based on the prediction model and may correspond to a decile as discussed above (e.g. any one of a sixth to ninth decile may be suitable for this purpose). Hence, in response to the in-game motion by a user being greater than the first threshold level of in-game motion, a reduction in the sensitivity setting can be provided. This may assist in improving usability of the controller device, and may potentially improve gameplay performance.

In response to a classification corresponding to a level of in-game motion lower than a second threshold level of in-game motion, the prediction circuitry 320 may be configured to predict the sensitivity update information for increasing the sensitivity setting for the given user operable input element. This may also assist in improving usability of the controller device, and may potentially improve gameplay performance.

More generally, an amount of in-game movement by a user achieved by physical movement with respect to a given user operable input element can be evaluated using the prediction model and sensitivity update information can be predicted for updating the sensitivity setting for the given user operable input element in a way that may potentially result in an amount of in-program movement that is considered more normal relative to the historical data for the plurality of users.

As explained above the prediction model is based on previous controller input information for a plurality of users. The previous controller input information may be historical controller input information for a plurality of users from a plurality of previous game sessions for one or more video games. The prediction model may thus use historical controller input information for a plurality of users for evaluating controller input information received by the receiving circuitry 310 and predicting one or more of whether to increase or decrease sensitivity and/or one or more values to be used for one or more parameters for a sensitivity setting. In some embodiments of the disclosure, the prediction model may comprise a trained machine learning model that has been trained using training data comprising the historical controller input information for the plurality of users. This is discussed in more detail below.

In some examples, the prediction model may use historical controller input information for a plurality of users with respect to a same video game title. Hence, the prediction model (or trained machine learning model) may be specific to a given video game title. In some examples, the prediction model may use historical controller input information for a plurality of users with respect to a same video game series comprising a plurality of related video game titles. An example may be a video game series comprising a plurality of related driving video games, or a video game series comprising a plurality of related first person shooter video games. In some examples, the prediction model may use historical controller input information for a plurality of users with respect to a same video game genre.

Alternatively or in addition, in some cases the prediction model may use historical controller input information for a plurality of users which has been obtained by filtering a larger set of historical controller input information. Hence, the prediction model may historical controller input information for a plurality of users which has been filtered according to one or more conditions. For example, filtering may be performed to obtain historical controller input information for a plurality of users of a given skill level. Examples of different skill levels may include beginner, intermediate and advanced. Of course, a more granular scheme may be used for classifying skill level. In some examples, a user may specify their skill level for a given game to be played and historical controller input information for a plurality of users of that same skill level can be used by the prediction model for the evaluation for that user's controller input information. Alternatively or in addition, a user may seek to improve their gameplay by requesting that their controller input information be evaluated using the prediction model based on historical controller input information for a plurality of users of a higher skill level than the user. For example, the current user may be a beginner but may wish to have their controller input information evaluated against advanced users so that sensitivity update information can be predicted for the current user according to the techniques above.

In some embodiments of the disclosure, the prediction circuitry 320 comprises one or more of a first prediction model based on historical controller input information for a respective video game title; a second prediction model based on historical controller input information for a plurality of respective video game titles each corresponding to a same video game series; and a third prediction model based on historical controller input information for a plurality of respective video game titles each corresponding to a same video game genre. Alternatively or in addition to this, historical controller input information for a respective video game title (or a game series or a video game genre) may be filtered according to skill level in accordance with the techniques discussed above.

The prediction circuitry 320 may comprise any suitable number of prediction models some of which may be specific to a given video game title, and/or some of which may be specific to a given video game series and/or some of which may be specified to a given video game genre. The controller input information received by the receiving circuitry 310 can thus be evaluated using a prediction model, in which the controller input information and the prediction model correspond to a same video game title, a same video game series and/or a same video game genre.

### Machine Learning

The prediction model may comprise a trained machine learning model that has been trained using training data comprising previous controller input information for a plurality of users. As mentioned previously, a prediction model may be specific to one of a given video game title, a given video game series and a given video game genre. Hence, the prediction circuitry 320 may comprise one or more of a first machine learning model trained using training data comprising historical controller input information for a respective video game title; a second machine learning model trained using training data comprising historical controller input information for a plurality of respective video game titles each corresponding to a same video game series; and a third machine learning model trained using training data comprising historical controller input information for a plurality of respective video game titles each corresponding to a same video game genre. Alternatively or in addition to this, historical controller input information for a respective video game title (or a game series or a video game genre) may be filtered according to skill level in accordance with the techniques discussed above to obtain filtered training data.

Machine learning techniques may be used in accordance with any of the techniques discussed above so as to input at least some of the controller input information associated with a given user operable input element into a trained machine learning model and obtain predicted sensitivity update information in dependence on an output of the machine learning model. Hence, the prediction model may comprise a trained machine learning model that has been trained using training data comprising the previous controller input information for the plurality of users to learn a function for mapping an input comprising at least controller input information associated with a given user operable input element to a target sensitivity setting.

In some examples, the machine learning model may have been trained using training data comprising the previous controller input information so as to learn a function for mapping an input indicative of a total amount of motion with respect to a given user operable input element over a period of time to at least one of: an output indicative of predicted sensitivity update information corresponding to an increment or a decrement of the current sensitivity setting by a given amount (e.g. increment of decrement by a predetermined amount); and an output indicative of predicted sensitivity update information indicative of a value to be used for a parameter associated with the sensitivity setting. For example, an excessively high amount of motion can be mapped to an output corresponding to an increase in the sensitivity setting and/or an excessively low amount of motion can be mapped to an output corresponding to a reduction in the sensitivity setting. In this way, the sensitivity setting can be varied so as to potentially control an amount of physical motion by the user to fall within a range of motion that is considered more normal according to the training data.

In some examples, the training data may comprising the previous controller input information so as to learn a function for mapping an input indicative of a total amount of motion with respect to a given user operable input element over a period of time and a current sensitivity setting to at least one of: an output indicative of predicted sensitivity update information corresponding to an increment or a decrement of the current sensitivity setting by a given amount (e.g. increment of decrement by a predetermined amount); and an output indicative of predicted sensitivity update information indicative of a value to be used for a parameter associated with the sensitivity setting. For example, an excessively high amount of in-program motion can be mapped to an output corresponding to a decrease in the sensitivity setting and/or an excessively low amount of in-program motion can be mapped to an output corresponding to an increase in the sensitivity setting. Therefore, the sensitivity setting can be varied so as to potentially control an amount in-program motion so as to fall within a range of-program motion that is considered more normal according to the training data.

In some examples, the machine learning model may be trained using labelled training data according to supervised learning techniques. The training data may comprise instances of controller information and associated labels indicative of a categorisation from two or more possible categorisations such as excessively high amount of motion and excessively low amount of motion. A more granular categorisation scheme may be used. Using such training data the machine learning model may be trained to learn a function that maps and input comprising received controller input information to an output (label) indicative of one of the two or more possible categorisations so as to classify the input. Hence, in response to predicting a category of an excessively high amount of motion, the output of the machine learning model can be used to predict sensitivity update information for updating the current sensitivity setting to increase sensitivity. Conversely, in response to predicting a category of an excessively low amount of motion, the output of the machine learning model can be used to predict sensitivity update information for updating the current sensitivity setting to decrease sensitivity. The above mentioned training data may be generated based on a statistical analysis of the instances of controller input information with labels being assigned accordingly. In a similar manner to that described above, the training data may in some cases comprise instances of controller information and associated labels indicative of a categorisation from two or more possible categorisations such as excessively high amount of in-program motion and excessively low amount of in-program motion and the techniques may be performed based on in-program motion in a manner similar to what has been discussed previously.

In some cases, the training data may comprise instances of controller input information and metadata indicating a degree of in-game success. For example, each instance of controller input information may be indicative of positional displacements of a control stick for a same portion of a video game and have associated metadata indicating a degree of in-game success for that portion of the video game. In the case of a shooter game, a degree of in-game success may relate to an amount of damage sustained (with less damage sustained correlating with higher success), or an amount of damage caused (e.g. a number of enemies killed). In the case of a driving game, a degree of in-game success may relate to a time associated with completion of a lap of a racing circuit or a portion thereof (e.g. between two bends), or a number of collisions.

The machine learning model may be trained using instances of controller input information to learn a relationship between positional displacements of a control stick, a sensitivity setting for the control stick and a degree of in-game success. For example, in response to an input comprising controller input information indicative of positional displacements of a control stick, the trained machine learning model can be operable to output sensitivity update information indicative of a target sensitivity for the control stick which correlates with an increase in in-game success (or correlated with a highest degree of in-game success).

In particular, a value for a parameter for a sensitivity of the control stick may have a possible range of values from 1 to 10, for example (in other example, a possible range may instead include positive and negative values such as a range from −5 to +5, or a range from 0 to 1). Using the training data, the machine learning model can learn, for differing amounts of control stick motion, which value of the parameter correlates with higher in-game success. For example, for a relatively low amount of control stick movement it may be learned that a value of 8 may correlate with high success, whereas for a relatively high amount of control stick movement it may be learned that a value of 3 may correlate with high success. Of course, this may differ from one video game to another, or may generally be the same for each video game of a same video game series or for each video game of a same video game genre.

Using the training data the machine learning model can learn a function for mapping an input comprising controller input data indicative of displacements for a user operable input element (e.g. control stick, trigger button or touchpad) to a target sensitivity which correlates with higher success. In this way, based on a user's expected level of movement for an input element (e.g. a control stick), a sensitivity setting can be provided which when used with the user's expected level of movement results in an improved level of success. Of course, if in response to a change in the sensitivity setting a user attempts to compensate by varying their level of movement, then this may have a counteracting or neutralising consequence. However, in some cases a modification to the sensitivity may be of a nature that the user is not aware, in which case the user's expected level of movement remains unchanged. In some examples, the above mentioned process may be subsequently repeated. For example, a threshold condition may be used to detect a threshold change in the level of physical movement by the user and thus the processing can be repeated by inputting more recent controller input information to the machine learning model to obtain other sensitivity update information.

Hence more generally, in some embodiments of the disclosure the training data comprises instances of controller input information for a plurality of users, each instance of controller input information having an associated sensitivity setting and associated metadata indicative of a degree of in-game success, the trained machine learning model having been trained using the training data to learn a relationship between displacements for the given user operable input element, a sensitivity setting for the given user operable element and a degree of in-game success, wherein the prediction circuitry 320 is configured to input at least the controller input information associated with the given user operable input element to the trained machine learning model and the trained machine learning model is operable to output the sensitivity update information indicative of a sensitivity setting for the given user operable input element correlated with an increase in in-game success.

In some embodiments of the disclosure, the training data may comprise instances of controller input information, in which the controller input information is indicative of one or more from the list consisting of: positional displacements for a control stick for a portion of a video game; positional displacements for a trigger button for the portion of the video game; and positions of touch inputs with respect to a touch pad for the portion of the video game. Hence, the prediction model may comprise a machine learning model trained to output sensitivity update information comprising one or more from the list consisting of: control stick sensitivity update information, trigger button sensitivity update information, and touchpad sensitivity information.

In some embodiments of the disclosure, the prediction circuitry 320 is operable to predict sensitivity update information indicative of one or more from the list consisting of: an indication to increase sensitivity; and indication to decrease sensitivity; and a sensitivity to be used instead of a current sensitivity. Hence, in some cases the prediction circuitry 320 may predict sensitivity update information that indicates than an update is to be applied to the current sensitivity setting for a user operable input element to increase sensitivity. In response to such predicted sensitivity update information, the update circuitry 330 can be operable to adjust at least one parameter of the current sensitivity setting by a fixed amount to thereby increase the sensitivity (e.g. increase a value of the parameter by a fixed amount for cases in which higher values are associated with higher sensitivity). Similarly, in some cases the prediction circuitry 320 may predict sensitivity update information that indicates than an update is to be applied to the current sensitivity setting for a user operable input element to decrease sensitivity. In response to such predicted sensitivity update information, the update circuitry 330 can be operable to adjust at least one parameter of the current sensitivity setting by a fixed amount to thereby decrease the sensitivity (e.g. decrease a value of the parameter by a fixed amount for cases in which lower values are associated with lower sensitivity). Alternatively or in addition, in some cases the predicted sensitivity update information may be indicative of a value to be used for a parameter. In response to such predicted sensitivity update information, the update circuitry 330 can be operable to adjust a value for the parameter of the current sensitivity setting to correspond to the value indicated by the predicted sensitivity update information.

Hence more generally, in some embodiments of the disclosure, the update circuitry 330 is configured to update the sensitivity setting for the given user operable input element in dependence on the sensitivity update information to increment or decrement a parameter associated with the sensitivity setting by a fixed amount. For example, modification of a value of a parameter by n % of the current value may be used (where n is an integer in the range 5-50%, and more preferably in the range 5-10%). In some examples, the sensitivity update information may be indicative of a value to be used for a parameter and the update circuitry 330 may increment or decrement the initial value by a fixed amount and repeat the operation after an elapse of a predetermined period of time to gradually transition to the value to be used for the parameter. In this way, a gradual transition in the sensitivity may be achieved. This can be particularly advantageous when the update is performed during a session for a video game since an abrupt and potentially large adjustment of sensitivity may be detrimental for a user.

In some embodiments of the disclosure, the sensitivity update information is indicative of a value to be used for a parameter associated with the sensitivity setting, and the update circuitry 330 is configured to update the sensitivity setting for the given user operable input element with the value for the parameter.

In some embodiments of the disclosure, the controller device is a two-handed controller device, wherein the prediction circuitry 320 is configured to predict second sensitivity update information for another user operable input element having another sensitivity setting, and wherein the given user operable input element is associated with a portion of the controller device for being operated by a first hand of a user and the another user operable input element is associated with another portion of the controller device for being operated by a second hand of the user. Hence, the techniques of the present disclosure may be used to update a sensitivity setting associated with a first user operable input element expected to be operated by a first hand of the user during normal use of the controller (e.g. a left hand holding a left handle section, such as 121L) and also update a sensitivity setting associated with another user operable input element expected to be operated by another hand of the user during the normal use of the controller (e.g. a right hand holding a right handle section, such as 121R).

In some embodiments of the disclosure, the given operable input element and the another user operable input element are respective control sticks. Hence, usability of a controller device comprising two control sticks operated by respective hands may be improved by updating a sensitivity setting for a first control stick to be operated by a first hand of the user and also updating a sensitivity setting for a second control stick to be operated by a second hand of the user. In particular, first controller input information generated responsive to operation by the user of a first control stick (e.g. a digit of that hand) can be received by the apparatus 300 and used for predicting first sensitivity update information for the first control stick based on how the user is operating the first control stick, and second controller input information generated responsive to operation by the user of a second control stick (e.g. a digit of that hand) can be received by the apparatus 300 and used for predicting second sensitivity update information for the second control stick based on how the user is operating the second control stick. Hence, for a case in which a user has differing levels of ability for their respective hands (e.g. a right handed user may have greater dexterity associated with their right hand than their left hand), the data processing apparatus 300 may be operable according to the techniques discussed above to update the sensitivity settings so that potentially a different sensitivity is used for the two controls sticks.

As explained previously, in some cases the receiving circuitry 310 may receive recorded controller input information for a previous session for a video game. The received controller input information may be a recording of user inputs for a controller device recorded during a previous session of a video game, and the prediction circuitry 320 may be configured to predict the sensitivity update information for updating the sensitivity setting for a given user operable input element to obtain the updated sensitivity setting in advance of a subsequent session of the video game or another video game. Hence, in some cases the techniques of the present disclosure may be performed as part of an offline process after completion of a game session to allow an update to one or more senility settings for use during a future session for a video game.

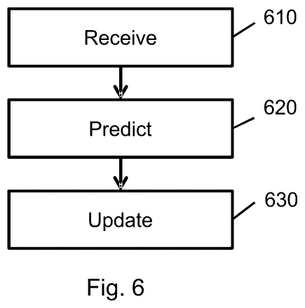

FIG. 6 is a schematic flowchart illustrating a computer-implemented method. The method comprising:

receiving (at a step 610) controller input information indicative of one or more user inputs for a controller device comprising one or more user operable input elements;

predicting (at a step 620), for a given user operable input element of the controller device having a sensitivity setting, sensitivity update information for updating the sensitivity setting for the given user operable input element, and updating (at a step 630) the sensitivity setting for the given user operable input element in dependence on the sensitivity update information to obtain an updated sensitivity setting for the given user operable input element, in which the step of predicting comprises predicting the sensitivity update information in dependence on at least some of the controller input information associated with the given user operable input element and a prediction model which is based on previous controller input information for a plurality of users.

FIG. 6 illustrates an example in which the method is performed to update the sensitivity setting at the step 630 and ends at the step 630. In some examples, the method of FIG. 6 may include a feedback loop so that after that step 630 the method may return to the step 610 and receive next controller input information and repeat the steps 620 and 630. In some examples, a condition, such as an elapse of a predetermined period of time, may follow the step 630 so that the method of FIG. 6 may be periodically repeated. In some examples, the update at the step 630 may comprise a number of progressive increments of decrements with respect to the sensitivity setting to allow for a more gradual adjustment.

It will be appreciated that example embodiments can be implemented by computer software operating on a general purpose computing system such as a games machine. In these examples, computer software, which when executed by a computer, causes the computer to carry out any of the methods discussed above is considered as an embodiment of the present disclosure. Similarly, embodiments of the disclosure are provided by a non-transitory, machine-readable storage medium which stores such computer software.

It will also be apparent that numerous modifications and variations of the present disclosure are possible in light of the above teachings. It is therefore to be understood that within the scope of the appended claims, the disclosure may be practised otherwise than as specifically described herein.

1. A data processing apparatus comprising:
receiving circuitry configured to receive controller input information indicative of one or more user inputs for a controller device comprising one or more user operable input elements;
prediction circuitry configured to predict, for a given user operable input element of the controller device having a sensitivity setting, sensitivity update information for updating the sensitivity setting for the given user operable input element; and
update circuitry configured to update the sensitivity setting for the given user operable input element in dependence on the sensitivity update information to obtain an updated sensitivity setting for the given user operable input element,
in which the prediction circuitry is configured to predict the sensitivity update information in dependence on at least some of the controller input information associated with the given user operable input element and a prediction model which is based on previous controller input information for a plurality of users, and
in which the prediction model comprises a trained machine learning model to predict the sensitivity update information, the trained machine learning model having been trained using training data comprising the previous controller input information for the plurality of users.

2. The data processing apparatus according to claim 1, wherein the given user operable input element is one of a control stick, a trigger button, and a touchpad of the controller device.

3. The data processing apparatus according to claim 1, wherein the controller input information is indicative of one or more from the list consisting of:
positional displacements for a control stick;
positional displacements for a trigger button; and
positions of touch inputs with respect to a touch pad.

4. The data processing apparatus according to claim 1, wherein the prediction circuitry is configured to predict the sensitivity update information for updating the sensitivity setting for the given user operable input element in dependence on at least some of the received controller input information indicative of positional displacements for the given user operable input element during a period of time and the prediction model.

5. The data processing apparatus according to claim 4, wherein the prediction circuitry is configured to predict the sensitivity update information for increasing sensitivity associated with the given user operable input element in dependence on whether the at least some of the received controller input information is indicative of an amount of motion exceeding a threshold amount of motion, the threshold amount of motion identified based on the prediction model.

6. The data processing apparatus according to claim 1, wherein the prediction circuitry is configured to use the prediction model to evaluate motion of the given user operable input element during a given period of time and the sensitivity setting for the given user operable input element relative to the previous controller input information for the plurality of users, and predict the sensitivity update information in dependence on the evaluation relative to the previous controller input information.

7. The data processing apparatus according to claim 6, wherein the prediction circuitry is configured to calculate an amount of in-game motion in dependence on the motion for the given user operable input element during the given period of time and the sensitivity setting for the given user operable input element, and the prediction circuitry is configured to use the prediction model to classify the received controller input information according to a classification from a plurality of candidate classifications corresponding to different levels of in-game motion.

8. The data processing apparatus according to claim 7, wherein in response to a classification corresponding to a level of in-game motion greater than a first threshold level of in-game motion, the prediction circuitry is configured to predict the sensitivity update information for decreasing the sensitivity setting for the given user operable input element.

9. The data processing apparatus according to claim 7, wherein in response to a classification corresponding to a level of in-game motion lower than a second threshold level of in-game motion, the prediction circuitry is configured to predict the sensitivity update information for increasing the sensitivity setting for the given user operable input element.

10. The data processing apparatus according to claim 1, wherein the training data comprises instances of controller input information, each instance of controller input information having an associated sensitivity setting and associated metadata indicative of a degree of in-game success, the trained machine learning model having been trained using the training data to learn a relationship between displacements for the given user operable input element, a sensitivity setting for the given user operable input element and a degree of in-game success, wherein the prediction circuitry is configured to input at least the controller input information associated with the given user operable input element to the trained machine learning model and the trained machine learning model is operable to output the sensitivity update information indicative of a sensitivity setting for the given user operable input element correlated with an increase in in-game success.

11. The data processing apparatus according to claim 1, wherein the update circuitry is configured to update the sensitivity setting for the given user operable input element in dependence on the sensitivity update information to increment or decrement a parameter associated with the sensitivity setting by a fixed amount.

12. The data processing apparatus according to claim 1, wherein the sensitivity update information is indicative of a value to be used for a parameter associated with the sensitivity setting, and the update circuitry is configured to update the sensitivity setting for the given user operable input element with the value for the parameter.

13. The data processing apparatus according to claim 1, wherein the controller device is a two-handed controller device, wherein the prediction circuitry is configured to predict second sensitivity update information for another user operable input element having another sensitivity setting, and wherein the given user operable input element is associated with a portion of the controller device for being operated by a first hand of a user and the another user operable input element is associated with another portion of the controller device for being operated by a second hand of the user.

14. The data processing apparatus according to claim 13, wherein the given user operable input element and the another user operable input element are respective control sticks.

15. The data processing apparatus according to claim 1, wherein the received controller input information is a recording of user inputs for the controller device recorded during a previous session of a video game, and the prediction circuitry is configured to predict the sensitivity update information for updating the sensitivity setting for the given user operable input element to obtain the updated sensitivity setting in advance of a subsequent session of the video game or another video game.

16. The data processing apparatus according to claim 1, comprising processing circuitry to process a session of a video game in dependence on the controller input information and the updated sensitivity setting.

17. A computer implemented method comprising:
receiving controller input information indicative of one or more user inputs for a controller device comprising one or more user operable input elements;
predicting, for a given user operable input element of the controller device having a sensitivity setting, sensitivity update information for updating the sensitivity setting for the given user operable input element; and
updating the sensitivity setting for the given user operable input element in dependence on the sensitivity update information to obtain an updated sensitivity setting for the given user operable input element,
in which the step of predicting comprises predicting the sensitivity update information in dependence on at least some of the controller input information associated with the given user operable input element and a prediction model which is based on previous controller input information for a plurality of users, and
in which the prediction model comprises a trained machine learning model to predict the sensitivity update information, the trained machine learning model having been trained using training data comprising the previous controller input information for the plurality of users.

18. A non-transitory computer readable storage medium storing instructions which, when executed by one or more processors of a computer, cause the computer to perform a method comprising:
receiving controller input information indicative of one or more user inputs for a controller device comprising one or more user operable input elements;
predicting, for a given user operable input element of the controller device having a sensitivity setting, sensitivity update information for updating the sensitivity setting for the given user operable input element; and
updating the sensitivity setting for the given user operable input element in dependence on the sensitivity update information to obtain an updated sensitivity setting for the given user operable input element,
in which the step of predicting comprises predicting the sensitivity update information in dependence on at least some of the controller input information associated with the given user operable input element and a prediction model which is based on previous controller input information for a plurality of users, and
in which the prediction model comprises a trained machine learning model to predict the sensitivity update information, the trained machine learning model having been trained using training data comprising the previous controller input information for the plurality of users.
